(19) United States
(12) Patent Application Publication
(10) Pub. No.: US 2025/0001300 A1
(43) Pub. Date: Jan. 2, 2025

(54) CONTROLLING IN-GAME REWARDS

(71) Applicant: Playtika LTD, Herzeliya (IL)

(72) Inventors: Moshe SALHOV, Herzeliya (IL); Armand Nicolas Jean VALSESIA, Chavannes Renes (CH); Alistair Joseph DOSWALD, Carrouge VD (CH); Leonid RAICHMAN, Holon (IL)

(73) Assignee: Playtika LTD, Herzeliya (IL)

(21) Appl. No.: 18/755,784

(22) Filed: Jun. 27, 2024

Related U.S. Application Data
(60) Provisional application No. 63/523,949, filed on Jun. 29, 2023.

(51) Int. Cl. A63F 13/537

(52) U.S. Cl. CPC A63F 13/537

(57) ABSTRACT

Disclosed herein is a method of improving user experience in conjunction with a computer game long-term factors by controlling rewards to players, comprising communicating with a game engine of a computer game to receive a plurality of behavior parameters relating to in-game actions of a plurality of players engaged in the computer game using a plurality of client devices, balancing between a user experience of one or more of the players and one or more long-term factors of the computer game by generating, based on the plurality of behavior parameters, one or more reward recommendations for allocating one or more rewards to one or more players for in-game actions made by the players, and causing the game engine to adjust a Graphic User Interface (GUI) of the client device of one or more of the players to reflect the one or more allocated rewards.

### RELATED APPLICATION(S)

This application claims the benefit of priority under 35 USC § 119 (e) of U.S. Provisional Patent Application No. 63/523,949 filed on Jun. 29, 2023, the contents of which are incorporated by reference as if fully set forth herein in their entirety

### FILED AND BACKGROUND OF THE INVENTION

The present invention, in some embodiments thereof, relates to controlling in-game rewards to players engaged in a computer game and, more specifically, but not exclusively, to controlling in-game rewards to players engaged in a computer game to balance between user experience and long-term factors of the computer game.

Computer games may be highly attractive as they may offer players multiple benefits such as, for example, fun, activity, and challenge, to name just a few.

Computer gaming has therefore long become a major field of interest for a constantly growing number of players (users) who may spend a significant portion of their time playing such computer games. This trend is constantly expanding in scale and scope due to the rapid and ever growing accessibility of users to client devices, for example, computers, Smartphones, tablets and/or the like which may be used for playing computer games.

Commercial sustainability of computer games vendors is dependent on players' engagement and satisfaction. Yet providing engaging and personalized experience to players is a significant challenge and ongoing endeavor. Computer game vendors therefore invest major resources to explore and apply techniques, tactics, and strategies for increasing players' user experience.

### SUMMARY OF THE INVENTION

According to a first aspect of the present invention there is provided a method of improving user experience in conjunction with a computer game long-term factors by controlling rewards to players, comprising using one or more processors for executing a recommendation engine adapted to:
Communicate with a game engine of a computer game to receive a plurality of behavior parameters relating to in-game actions of a plurality of players engaged in the computer game using a plurality of client devices.
Balance between a user experience of one or more of the plurality of players and one or more long-term factors of the computer game by generating, based on the plurality of behavior parameters, one or more reward recommendations for allocating one or more rewards to one or more players for one or more in-game actions made by the one or more players.
Cause the game engine to adjust a Graphic User Interface (GUI) of the client device of one or more of the plurality of players to reflect the one or more allocated rewards.

According to a second aspect of the present invention there is provided a system for improving user experience in conjunction with a computer game long-term factors by controlling rewards to players, comprising one or more processors adapted to execute a code of a recommendation engine. The code comprising:
Code instructions to communicate with a game engine of a computer game to receive a plurality of behavior parameters relating to in-game actions of a plurality of players engaged in the computer game using a plurality of client devices.
Code instructions to balance between a user experience of one or more of the plurality of players and one or more long-term factors of the computer game by generating, based on the plurality of behavior parameters, one or more reward recommendations for allocating one or more rewards to one or more players for one or more in-game actions made by the one or more players.
Code instructions to cause the game engine to adjust a GUI of the client device of one or more of the plurality of players to reflect the one or more allocated rewards.

According to a third aspect of the present invention there is provided a computer program product of a recommendation engine adapted to improve user experience in conjunction with a computer game long-term factors by controlling rewards to players, comprising a non-transitory medium storing thereon computer program instructions which, when executed by one or more hardware processors, cause the one or more hardware processors to:
Communicate with a game engine of a computer game to receive a plurality of behavior parameters relating to in-game actions of a plurality of players using a plurality of client devices to play the computer game.
Balance between a user experience of one or more of the plurality of players and one or more long-term factors of the computer game by generating, based on the plurality of behavior parameters, one or more reward recommendations for allocating one or more rewards to one or more players for one or more in-game actions made by the one or more players.
Cause the game engine to adjust a GUI of the client device of the one or more of the plurality of players to reflect the one or more allocated rewards.

In an optional implementation form of the first, second and/or third aspects, one or more trained Machine Learning (ML) models are applied to generate the one or more reward recommendations.

In a further implementation form of the first, second and/or third aspects, the plurality of behavior parameters relating to in-game actions of the plurality of players comprise one or more members of a group comprising: engagement time, a churn rate, a growth in number of new players, a retention rate of new players, an in-game action, advancement of players within the computer game, a player interaction, and/or a value of rewards aggregated by the plurality of players.

In a further implementation form of the first, second and/or third aspects, the one or more rewards comprise one or more members of a group comprising: an asset, a token, an Experience Point (XP), a gaming clue, a level advancement, an in-game advantage, an in-game skill, and/or a monetary value.

In a further implementation form of the first, second and/or third aspects, the one or more long-term factors are expressed by one or more parameters selected from a group comprising: a value of assets aggregated by the players, a value of assets spent by the players, a ratio between the aggregated assets and the spent assets, a rate of asset purchasing by the players, an inflation rate of assets gained by the players, and/or a ratio between assets gained by at least some of the plurality of players.

In a further implementation form of the first, second and/or third aspects, the balancing is based on a plurality of constraints defining at least that: the increase of assets gained by the one or more players exceeds a predefined threshold, and the one or more long-term factors are within respective predefined ranges.

In an optional implementation form of the first, second and/or third aspects, the recommendation engine is further adapted to generate a sequence of reward recommendations estimated to comply with the plurality of constraints.

In an optional implementation form of the first, second and/or third aspects, the recommendation engine is further adapted to test a plurality of alternative sequences of reward recommendations to identify and select an optimal sequence of the plurality of alternative sequences.

In an optional implementation form of the first, second and/or third aspects, the recommendation engine is further adapted to generate an additional sequence of reward recommendations responsive to a failure of one or more previous sequences to comply with the plurality of constraints.

In an optional implementation form of the first, second and/or third aspects, the additional sequence and/or the one or more failed sequences are used to further train one or more ML models adapted to generate the sequence of reward recommendations.

In an optional implementation form of the first, second and/or third aspects, the recommendation engine is further adapted to apply one or more adverse result limitation constraints to the balancing. The one or more adverse result limitation constraints are selected form a group consisting of: a predefined engagement time limit, and/or a predefined monetary value spending limit.

In an optional implementation form of the first, second and/or third aspects, the recommendation engine is further adapted to group the plurality of players into a plurality of player groups, collect a plurality of sets of behavior parameters each relating to respective one of the plurality of player groups, compute a combination of reward recommendations comprising one or more respective reward recommendations for each of the plurality of player groups generated based on a respective one of the plurality of sets, and cause the game engine to allocate one or more rewards to one or more players of each of the plurality of player groups according to the respective one or more reward recommendations.

In an optional implementation form of the first, second and/or third aspects, the recommendation engine is further adapted to generate the combination of reward recommendations based on mutual impact between players of different groups.

In an optional implementation form of the first, second and/or third aspects, the recommendation engine is further adapted to generate the reward recommendations according to one or more distributions of rewards among the plurality of player groups.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

### In the Drawings:

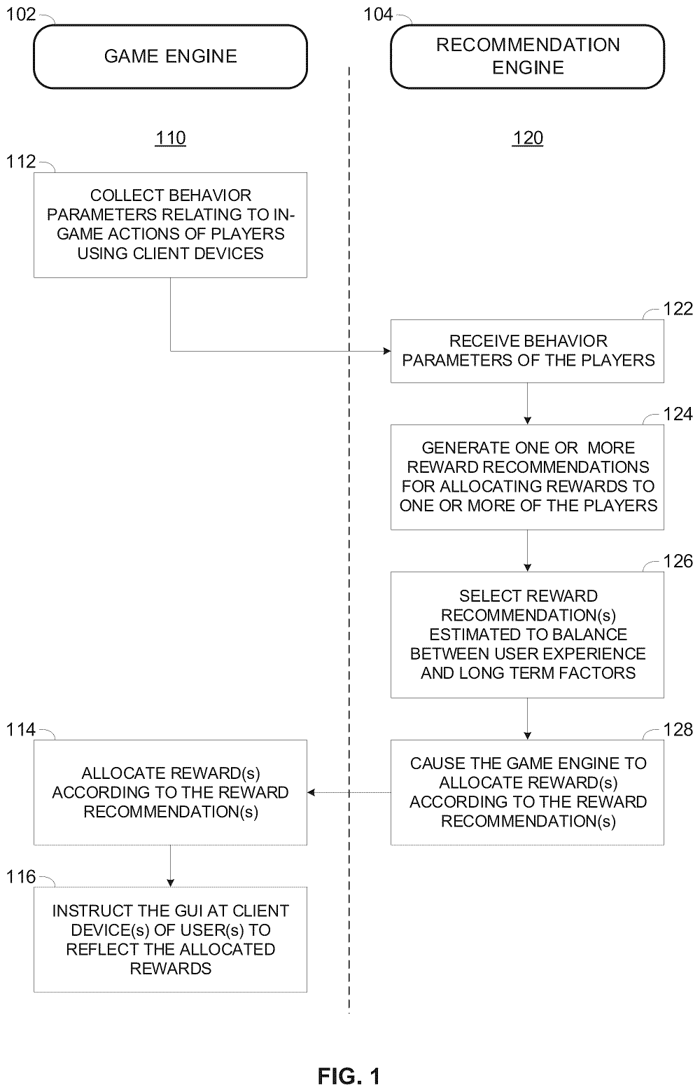

FIG. 1 is a flowchart of an exemplary process of controlling in-game rewards to improve user experience of a computer game in conjunction with game long-term factors, according to some embodiments of the present invention; and

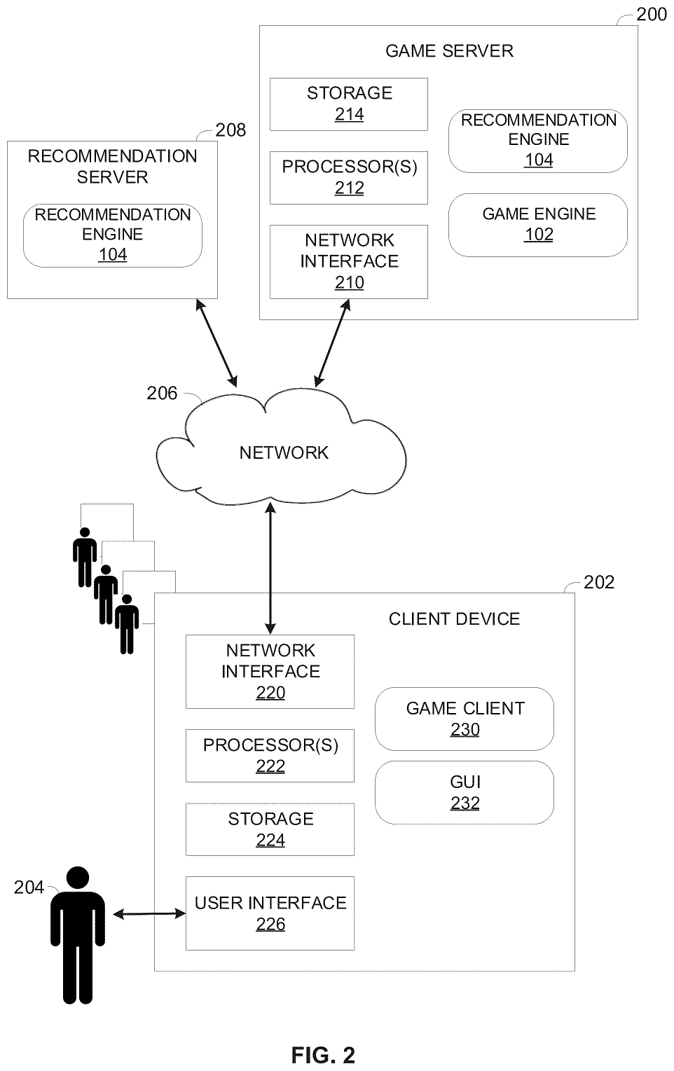

FIG. 2 is a schematic illustration of an exemplary system for controlling in-game rewards to improve user experience of a computer game in conjunction with game long-term factors, according to some embodiments of the present invention.

### DESCRIPTION OF SPECIFIC EMBODIMENTS OF THE INVENTION

The present invention, in some embodiments thereof, relates to controlling in-game rewards to players engaged in a computer game and, more specifically, but not exclusively, to controlling in-game rewards to players engaged in a computer game to balance between user experience and long-term factors of the computer game.

Rewarding players of computer games for their in-game actions, achievements, progress, and/or the like has been proved to be most effective for improving the player's user experience which may translate to increased play time (engagement time), high user retention, reduced churn rate, increased expenditure by the players, and more.

However, while allocating rewards (rewarding) to the players, for example, tokens, in-game assets, monetary value, clues, skills, characters, difficulty levels, quests/challenges and/or the like may significantly increase the players' user experience, typically in the short-term, an uncalculated or unpremeditated by-product may lead to undesirable long-term effects and/or impacts.

Game economy may be therefore applied and managed in order to create an engaging and balanced experience for players while resulting in preservation and possibly increase of one or more long-term aspects of the computer game, for example, appeal, value, reputation and/or the like.

Such objectives and goals driven by the game economy may include, for example, balance and progression of game resources (assets) to balance (adjust) distribution and availability of assets to create a sense of progression and challenge such that, for example, assets are not too scarce as to prevent players from making progress, or too abundant thus diminishing the value and satisfaction derived from acquiring them. In another example, the game economy may be set to control and prevent inflation of assets which may devaluate them, i.e., decrease their value.

In order to monitor and/or control the game economy in attempt to achieve the computer game desired behaviors, goals, and/or results, long-term factors of the computer game may be monitored and controlled accordingly. Such long-term factors may include, for example, value of assets aggregated by players, value of assets spent and/or gained by players, a ratio between aggregated and spent assets, a rate of assets purchasing, an inflation or deflation rate of assets, ratio of assets held by groups of players and/or the like.

According to some embodiments of the present invention, there are provided methods, systems and computer program products for generating and applying reward recommendations for allocating rewards (rewarding) to players engaged in (playing) a computer game using respective client devices, for example, a computer, a mobile device (e.g., Smartphone, tablet, etc.), a proprietary client device, and/or the like.

In particular, the reward recommendations may be generated and selected for allocating rewards, for example, assets, tokens, Experience Points (XP), clues, level advancements, in-game advantages, in-game skills, in-game characters, in-game properties, monetary value and/or the like in attempt to balance between improving a user experience of one or more of the players and one or more of the long-term factors of the computer game.

The reward recommendations may be generated and/or computed based on analysis of a plurality of behavior parameters, specifically in-game behavior parameters relating to in-game actions and/or achievements of the players engaged in the computer game. The behavior parameters may comprise, for example, engagement behavior parameters (e.g., engagement time, a churn rate, a number of new players, a retention rate, etc.), in-game action behavior parameters (e.g., progress of players in the game, skills of players, player interaction with each other and/or with features of the game, etc.), asset behavior parameters (e.g., in-game assets and/or rewards gained, lost, spent, accumulated, and/or aggregated by the players, etc.), and/or the like.

Analysis of the behavior parameters may therefore reveal, expose, and/or indicate of one or more behavioral patterns, trends, conditions, and/or the like and reward recommendations estimated to balance between the players user experience and one or more of the long-term factors of the computer game may be therefore generated and/or computed accordingly.

Rewards allocated according to the reward recommendations may be reflected to the players via their respective client devices, for example, by adjusting and/or controlling a Graphic User Interface (GUI) executed by the client devices.

Optionally, one or more sequences of reward recommendations may be generated and applied for allocating rewards to players in a sequence, for example, over certain time periods, and/or in response to certain behavioral parameters observed for the players. As such, rather than generating individual reward recommendations which are independent of each other, one or more sequences of reward recommendations which may be generated applied over time to jointly define reward strategy or tactic which may eventually balance between the user experience of at least some of the players and one or more of the long-term factors.

Optionally, the players may be divided into one or more player groups (categories) according to one or more player attributes and one or more combinations of reward recommendations may be generated and applied in conjunction to each of at least some of the player groups, meaning that each combination may combine reward recommendations for at least some of the player groups. Moreover, one or more sequences of combinations of reward recommendations may be generated for the multiple player groups in attempt to balance between the user experience of the players and the long-term factors.

Optionally, one or more Machine Learning (ML) models, for example, a neural network, a classifier, Bayesian systems, Reinforcement Learning, and/or the like may be adapted and trained to generate one or more reward recommendations.

Computing reward recommendations and allocating rewards accordingly to players of the computer game may present significant benefits and advantages.

First, rewarding the players may maintain and possibly improve the user experience of at least a majority of the computer game players thus increasing their engagement with the computer game, at least short-term engagement. Maintaining a balanced game economy, in which the user experience is maintained and possibly improved while the serving also the computer game's long-term factors may maintain and potentially increase long-term appeal, value, and/or reputation of the computer game to the benefit of the computer game vendor.

Moreover, generating the reward recommendations based on analysis of the behavior parameters observed for the players engaged in the computer game may lead to significantly more accurate reward recommendations since rewards may be allocated to players in direct correlation with their in-game actions, achievements, and/or the like thus significantly improving their user experience.

Furthermore, generating sequences of reward recommendations for rewarding players over time and/or in response to certain in-game actions and/or achievements, as derived from analysis of the behavior parameters, rather than independently allocating rewards may further improve and/or increase accuracy of balancing between the players' user experience and the long-term factor(s) of the computer game.

In addition, segmenting the players into multiple payer groups and/or categories according to their player attributes and generating combinations of reward recommendations combining reward recommendations for at least some of the player groups may enable focusing and adjusting the reward recommendations for each player group according to its characterizing player attribute(s) thus further improving and/or increasing accuracy of the balance between the players' user experience and the long-term factor(s) of the computer game.

Also, applying online machine learning to provide dynamic reward recommendation may be significantly advantageous in its ability to provide new game experience that wasn't released previously to players, and/or to new classes of players who have never benefitted from such experience in the past.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Python, Java, Scala, Smalltalk, C++ or the like, and conventional procedural programming languages, such as the “C” programming language or similar programming languages including and not limited to statistical languages such as, for example, R, MATLAB, SPSS, Statistica, SAS/JMP, and/or the like.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring now to the drawings, FIG. 1 is a flowchart of an exemplary process of controlling in-game rewards to improve user experience of a computer game in conjunction with game long-term factors, according to some embodiments of the present invention.

An exemplary process 120 may be executed by a recommendation engine 104 to generate one or more reward recommendations for allocating rewards (rewarding) to one or more of a plurality of players engaged in a computer game using respective client devices.

In particular, the recommendation engine 104 may generate and select reward recommendations to balance between improving a user experience of one or more of the players and one or more long-term factors of the computer game which are directed to maintain a value of game assets gained and/or spent by the players over time.

The recommendation engine 104 may therefore generate and select reward recommendations according to behavior parameters relating to the plurality of players which are collected by a game engine 102 adapted to control the computer game. The behavior parameters relating to in-game actions of the players are collected by the game engine 102 executing an exemplary process 110 during which the game engine 102 may further instruct a GUI at one or more of the client devices to reflect the rewards awarded (allocated, granted) to players according to the reward recommendations.

Reference is also made to FIG. 2, which is a schematic illustration of an exemplary system for controlling in-game rewards to improve user experience of a computer game in conjunction with game long-term factors, according to some embodiments of the present invention.

A game server 200 may execute a game engine 102 to control a computer one or more computer games in which a plurality of players (users) 204 may engage (play) using their respective client devices 202.

The game server 200, for example, a server, a computing node, a cluster of computing nodes, and/or the like may include a network interface 210, a processor(s) 212, and a storage 214 for storing data and/or code (program store).

The network interface 210 may comprise one or more network adapters for connecting to a network 206 comprising one or more wired and/or wireless networks, for example, a Local Area Network (LAN), a Wireless LAN (WLAN, e.g. Wi-Fi), a Wide Area Network (WAN), a Metropolitan Area Network (MAN), a cellular network, the internet and/or the like. Via the network 206 the game server 200 may communicate with the plurality of client devices 202 to serve and control the computer game.

The processor(s) 212, homogenous or heterogeneous, may include one or more processing nodes and/or cores arranged for parallel processing, as clusters and/or as one or more multi core processor(s).

The storage 214 may include one or more non-transitory persistent storage devices, for example, a Read Only Memory (ROM), a Flash array, a Solid State Drive (SSD), a hard drive (HDD) and/or the like. The storage 214 may also include one or more volatile devices, for example, a Random Access Memory (RAM) component, a cache and/or the like. Optionally, the storage 214 may further include one or more network storage devices accessible via the network interface 210, for example, a Network Attached Storage (NAS), a storage server, and/or the like.

The processor(s) 212 may execute one or more software modules such as, for example, a process, a script, an application, an agent, a utility, a tool, an Operating System (OS) and/or the like each comprising a plurality of program instructions stored in a non-transitory medium (program store) such as the storage 214 and executed by one or more processors such as the processor(s) 212. Optionally, the processor(s) 212 may include one or more hardware elements available by the game server 200, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU) and/or the like.

The processor(s) 212 may therefore execute one or more functional modules utilized by one or more software modules, one or more of the hardware elements and/or a combination thereof. For example, the processor(s) 212 may execute the game engine 102 adapted to serve computer game(s) to the client devices 202. In another example, the processor(s) 212 may execute the recommendation engine 104 to execute the process 120 for generating reward recommendations for rewarding players 204.

Optionally, the recommendation engine 104 may be integrated within the game engine 102 such that the game engine 102 is a single functional module executing both the process 110 and the process 120. However, even if integrated together, the process 110 and the process 120 may be typically separate from each other and may interact with each other as described herein.

Optionally, the recommendation engine 104 may be utilized, implemented, and/or executed by one or more other servers such as the game server 200, designated recommendation server 208, which may be in communication with the game server 200, specifically with the game engine 102, for example, via the network 206, to receive game information and generate reward recommendations based on that game information.

Optionally, the game server 200 and/or the recommendation server 208, specifically the game engine 102 and/or the recommendation engine 104 respectively, may be provided, executed and/or utilized by one or more cloud computing services, platforms, and/or infrastructures, for example, Infrastructure as a Service (IaaS), Platform as a Service (PaaS), Software as a Service (SaaS), and/or the like such as, for example, Google Cloud™, Microsoft Azure®, Amazon Web Service® (AWS) and Elastic Compute Cloud® (EC2), IBM Cloud®, and/or the like.

Each client device 202, for example, a desktop computer, a laptop computer, a Smartphone, a tablet, a proprietary client device and/or the like may include a network interface 220 such as the network interface 210, a processor(s) 222 such as the processor(S) 212, a storage 224 such as the storage 214 for storing data and/or code (program store), and a user interface 216 for interacting with a respective player 204.

The network interface 220 may comprise one or more network wired and/or wireless adapters for connecting to a network such as the network 206 and communicating with one or more remote network resources, for example, the game server 200.

As described for the processor(s) 212, the processor(s) 222 may execute one or more software modules such as, for example, a process, a script, an application, an agent, a utility, a tool and/or the like each comprising a plurality of program instructions stored in a non-transitory medium (program store) such as the storage 224 and executed by one or more processors such as the processor(s) 222. Optionally, the processor(s) 222 may include one or more hardware elements available by the client device 202, for example, a circuit, a component, an IC, an ASIC, an FPGA, a DSP, a GPU and/or the like.

The processor(s) 222 may therefore execute one or more functional modules utilized by one or more software modules, one or more of the hardware elements and/or a combination thereof. For example, the processor(s) 222 may execute a game client 230 adapted to execute one or more computer games at the client device 202, for example, game logic, image rendering, audio generation, tactile stimulation, user interaction, and/or the like.

The processor(s) 22 may further execute a GUI 232 for controlling visual content presented to the player 204 via one or more visual interfaces of the client device 202. For example, a display, a screen, a 3D projector such as, for example, a Virtual Reality (VR) device (e.g., goggles, Head Mounted Display (HMD), etc.) and/or the like. It should be noted that the term GUI as used herein may be directed to user interaction in general, rather than only visual interaction, and may include audio interaction, tactile interaction, and/or the like.

As known in the art, computer games, specially computer gamers served and/or supported by game servers such as the game server 200 may employ multiple different deployment, architectures. and/or implementations. While such aspects of computer game architecture are beyond the scope of this disclosure, some exemplary deployments are briefly described herein.

For example, in some deployments, game logic, rendering, user integration, and/or the like may be controlled by a high-capacity game agent 230 locally executed by one or more of the client devices 202 while one or more higher level actions, for example, player to player interaction, game statistics, game community, long-term factors and/or objectives, monetization, and/or the like may be controlled by the game engine 102 executed by the game server 200. In another example, game logic, and/or rendering may be distributed between the game engine 102 and the game agent 230 locally executed by one or more of the client devices 202 or even mainly executed by the game engine 102 such that the game agent 230 may be significantly limited and may serve mainly to relay rendering instructions from the remote game engine 102 to the local GUI 232 and user interactions from the client device 202 to the game engine 120.

For brevity, regardless of the exact deployment, architecture and/or implementation of the computer games, the game engine 220 is described to execute the process 110 for collecting behavior parameters relating to the players 204 and further for controlling the GUI 232 either directly via a limited game agent 230 and/or indirectly by communicating with a high-capacity game agent 230 to instruct the game agent 230 to control and/or adjust the GUI 232.

Moreover, the processes 110 and 120 are described for a single computer game engaged (played) by a plurality of players 204. This, however, should not be construed as limiting since the same processes 110 and 120 may be expanded and scaled for a plurality of computer games engaged by the plurality of players 204 using a plurality of respective client devices 202.

As shown at 112, the process 110 starts with the game engine 102 collecting a plurality of behavior parameters, specifically in-game behavior parameters relating to in-game actions of the plurality of players 204 engaged in the computer game using their client devices 202.

One or more in-game behavior parameters relating to in-game actions of the players 204 while engaged with the computer game may comprise and/or be associated with, for example, one or more engagement behavior parameters, for example, an engagement time indicative of time or an amount of time one or more players 204 play the computer game. In another example, the behavior parameters may include a churn rate indicative of players 204 who stop playing and/or leave the game environment expressed, for example, in percentage of the overall players 204. In another example, the behavior parameters may include a growth in number of new players 204. In another example, the behavior parameters may include a retention rate of new players 204.

In another example, one or more behavior parameters may comprise and/or be associated with one or more in-game action behavior parameters, for example, an in-game action conducted by one or more players 204, an advancement and/or progress of one or more players 204 within the computer game (e.g., level, episode, etc.), a level of game skill of one or more players 204, a player interaction, for example, inter-user connectivity expressing interaction of one or more players 204 with one or more other players 204, and/or interaction of one or more players 204 with one or more in-game entities of the game, for example, an element, an object, a character, and/or the like.

In another example, one or more behavior parameters may comprise and/or be associated with one or more asset behavior parameters relating to one or more in-game assets and/or rewards, gained, spent, allocated, and/or lost by and/or to one or more of the players 204, for example, an asset, a token, an Experience Point (XP), a gaming clue, a level advancement, an in-game advantage, an in-game skill, an in-game character, an in-game property, an in-game virtue, a monetary value and/or the like. Such asset behavior parameters may include, for example, a value of assets gained and/or spent by one or more players 204, a value of assets aggregated by the plurality of players 204, a value of assets aggregated by one or more groups (subsets) of players 204, a value of rewards aggregated by the plurality of players 204, and/or the like.

As shown at 122, the process 120 starts with recommendation engine 104 communicating with the game engine 102 to receive the behavior parameters collected by the game engine 102.

The recommendation engine 104 may communicate with the game engine 102 via one or more interfaces, channels and/or infrastructures. For example, the recommendation engine 104 may communicate with the game engine 102 via one or more Application Programming Interfaces (API) of the game engine 102 and/or of the recommendation engine 104. In another example, the recommendation engine 104 may communicate with the game engine 102 via one or more messaging channels available at the game server 200, for example, an OS system call, a message queue, and/or the like. in another example, in case the recommendation engine 104 is integrated with the game engine 102, communication between the recommendation engine 104 and the game engine 102 may be facilitated by the programming language(s) used to code these modules.

As shown at 124, the recommendation engine 104 may generate one or more reward recommendations for allocating one or more rewards to one or more players 204 for one or more in-game actions made (conducted) by the respective player 204.

In particular, the recommendation engine 104 may generate one or more reward recommendations based on the plurality of behavior parameters to balance between a user experience of one or more of the players 204 and one or more long-term factors of the computer game. In other words, the generated reward recommendations are estimated to balance between the user experience of one or more players 204 which may be expressed by one or more behavior parameters and the long-term factors which may express game economy of the computer game.

As described herein before, the rewards may include, for example, an asset, a token, an XP, a gaming clue, a level advancement, an in-game advantage, an in-game skill, an in-game character, an in-game property, an in-game virtue, a monetary value and/or the like. Therefore allocating one or more rewards (rewarding) to one or more players 204 is estimated to improve the user experience standing on one end of the balance which may be expressed by an effect on one or more behavior parameters, for example, an increased engagement time a reduced churn rate, an increased growth in number of new players 204, and/or the like.

The long-term factors standing on the other side of the balance express game economy of the computer game and may include, for example, a value of assets aggregated by the players 204, a value of assets spent by the players 204, a ratio between the aggregated assets and the spent assets, a rate of assets purchasing by the players 204, an inflation rate of assets gained by the players 204, a ratio between assets gained by one or more groups of players 204 each containing at least some of the plurality of players 204, and/or the like.

The inflation rate, for example, which is associated with in-game assets, for example, tokens, monetary value, and/or the like may result of from excessive reward allocation to players 204 which may lead to devaluation of the assets and thus adversely affect the game economy.

For example, allocating a significant reward, for example, a valuable asset, a substantial monetary value, and/or the like to each player 204 for successful completion of each trivial in-game action may impact one or more game economics, specifically, significant increase the inflation rate of in-game assets which may devaluate the asset's value and may eventually lead to increased churn rate, reduced retention rate, and/or the like due to the little, insignificant, or no value of the assets.

In another example, one or more long-term factors may include a rate at which players 204 purchase in-game assets, for example, tokens using real money. In yet another example, one or more long-term factors may include one or more fairness parameters reflecting an imbalance between one or more players 204 having too many in-game assets compared to one or more other players 204. Improving such fairness parameters may therefore promote fairness among the players 204.

The recommendation engine 104 may therefore analyze the behavior parameters observed for the players 204 to identify one or more behavioral patterns, trends, conditions, and/or the like and generate accordingly one or more reward recommendations to balance between the user experience of one or more players 204 and long-term factors optionally based on a plurality of constraints defining one or more criteria, conditions, and/or the like.

For example, one or more constraints may define that an increase of assets gained by one or more players 204 exceeds a predefined threshold. In another example, one or more constraints may define that one or more long-term factors are within respective predefined ranges. In another example, one or more constraints may define that an effect of the rewards on one or more certain in-game behaviors should be kept above a certain threshold. In another example, one or more constraints may define to keep one or more long-term factors at a certain desired predetermined range. For example, a certain constraint may define that in response to rewards allocation to one or more players 204, the assets inflation should be with a certain range, for example, between an increase of 2% to 3%. In another example, a certain constraint may define that rewarding a certain player 204 should maintain the assets of the certain player 204 above a certain threshold. Moreover, one or more constraints may define that as result of rewarding the certain player 204, the assets of one or more other players 204 should be also maintained above a similar or different threshold.

Optionally, the recommendation engine 104 may be further adapted to generate a sequence of reward recommendations, for allocating rewards to players over one or more time periods, and/or responsive to one or more observed behavior parameters, which is estimated to balance between the user experience of the players and the long-term factors, optionally according to the constraints.

This means that rather than generating individual reward recommendations which are independent of each other, the recommendation engine 104 may generate a sequence of reward recommendations which may be applied over time and may jointly may define reward strategy or tactic which will eventually achieve the balance between user experience of one or more players 204 and one or more long-term factors, optionally as defined by one or more of the constraints.

For example, the recommendation engine 104 may estimate that a balance between user experience of one or more players 204 and one or more long-term factors according to one or more of the constraints may be achieved by allocating a first reward to a first player 204 for a first in-game action, followed by allocating a second reward to a second and third players 204 for a second in-game action, followed by allocating a third reward to a fourth player 204 for a third in-game action, and finally allocating a fourth reward to four other players 204 for a fourth and fifth in-game actions. The recommendation engine 104 may thus generate a sequence of reward recommendations for allocating rewards to the players 204 according to the estimation.

As shown at 126, the recommendation engine 104 may select one or more reward recommendations estimated to best balance between the user experience of one or more players 204 and one or more of the long-term factors as defined by one or more of the constraints.

Optionally, the recommendation engine 104 may test a plurality of alternative sequences of reward recommendations to identify and select an optimal sequence of reward recommendations from the plurality of alternative sequences. For example, the recommendation engine 104 may simulate an allocation of rewards according to each reward recommendation of each of multiple alternative sequences of reward recommendations to evaluate which sequence may yield a balance between the user experience of one or more players 204 and one or more of the long-term factors as defined by one or more of the constraints. Based on the evaluation, the recommendation engine 104 may select one of the plurality of alternative reward recommendations sequences which is estimated to best balance between the user experience of one or more players 204 and one or more of the long-term factors as defined by the constraint(s).

Simulation of the reward recommendation sequences may be done using one or more simulation models constructed based on typical behavior parameters observed over time, preferably a substantial time period (e.g., day, week, month, etc.) for a plurality of users such as the users 204 playing the computer game.

Optionally, the recommendation engine 104 may be further adapted to apply one or more adverse result limitation constraints to the balancing between the experience of one or more players 204 and one or more of the long-term factors. The adverse result limitation constraints may be defined to prevent the players 204 from experiencing one or more adverse personal results. For example, one or more adverse result limitation constraints may define a predefined engagement time limit to prevent one or more players 204 from playing the computer game for extended time periods exceeding the predefined engagement time limit. In another example, the adverse result limitation constraints may include a predefined monetary value spending limit to prevent one or more players 204 from spending amounts (value) of real money which exceed the predefined monetary value spending limit while in their engagement with the computer game.

According to some embodiments, the recommendation engine 104 may be adapted to target different types of players engaged in the computer game in attempt to improve the balance between user experience and long-term factors of the computer game by categorizing and/or segmenting the community of players 204 to distinct player groups and generate combinations of reward recommendations for each player group such that each combination may combine reward recommendations for at least some of the player groups

To this end, the recommendation engine 104 may group and/or categorize the plurality of players 204 into a plurality of player groups according to one or more player attributes of the players 204. For example, the recommendation engine 104 may group the players 204 into two groups, a first group of novice players 204 having limited (little) experience playing the computer game, i.e., having overall engagement time below a certain threshold and a second group containing experienced players 204 having overall engagement time with the computer game which exceeds the certain threshold. In another example, the recommendation engine 104 may group the players 204 into two skill groups, for example, a first group of unskilled players 204, and a second group of highly skilled players 204. In another example, the recommendation engine 104 may group the players 204 into three age groups, for example, a first group of young players 204, for example, younger than 16, a second group of players 204 in the ages between 16 and 25 and a third group of players 204 older than 25.

The recommendation engine 104 may collect and/or arrange the plurality of behavioral parameters according to the player groups such that a plurality of sets of behavior parameters may be collected each relating to respective one of the plurality of player groups.

The recommendation engine 104 may then compute a combination of reward recommendations comprising one or more respective reward recommendations for each of the plurality of player groups (categories) in conjunction, where the reward recommendation(s) generated for each player group is generated based on a respective set of behavior parameters relating to the players 204 of the respective player group.

Specifically, the recommendation engine 104 may generate a combination of reward recommendations estimated to balance between the user experience of one or more players 204 and one or more of the long-term factors as defined by one or more of the constraints.

For example, the recommendation engine 104 may generate a combination of reward recommendation comprising a first reward recommendation directed to reward a higher reward (e.g., more valuable) to players 204 of a first player group comprising novice players 204 and a second reward recommendation directed to reward lower rewards (e.g., less valuable) to layers 204 of a second player group comprising skilled players 204. This combination of reward recommendations may increase the user experience of the novice players 204 and may increase their retention while preventing excessive rewards to the more experienced and skilled players 204 thus prevent inflation of assets and/or maintain a ration between the assets gained by the skilled players and the assets already owned by these players 204.

Optionally, the recommendation engine 104 may generate a combination of reward recommendations for players 204 of multiple different groups based on mutual impact between players of the different groups. For example, rewarding a first group of players 204, for example, new players 204 with significantly high rewards may have a negative impact on a second group of players 204 who have been playing the computer game for a long time, for example, a month, a year, and/or the like. To prevent such negative impact, the recommendation engine 104 may therefore generate a combination of reward recommendation(s) defining reduced rewards to the first group of new players 204 and reward recommendation(s) defining increased rewards to the second group of long-time players 204.

Optionally, the recommendation engine 104 may generate a combination of reward recommendations for players 204 of multiple different groups according to one or more distributions of rewards among the plurality of player groups.

For example, the recommendation engine 104 may generate a combination of reward recommendations according to a certain distribution defining distribution of 60% of the rewards (value, amount, etc.) to a first group of new players 204 and 40% of the rewards to a second group of old-time players 204 since this distribution is estimated to balance between the user experience of the players 204 of both groups and one or more of the long-term factors.

In another example, the recommendation engine 104 may generate a combination of reward recommendations according to another distribution defining distribution of 50% of the rewards (value, amount, etc.) among a first group of players 204 which did not yet reach a certain level (e.g., level, episode, etc.) in the computer game and 50% of the rewards to a second group of players 204 who have passed the certain level since this distribution is estimated to balance between the user experience of the players 204 of both groups and one or more of the long-term factors.

In another example, the recommendation engine 104 may generate a combination of reward recommendations according to another distribution defining a certain mixture of reward types, for example, a certain amount of monetary value rewards, a certain amount of in-game advancement rewards (e.g., clue, skill, character, etc.), a certain amount of inter-player rewards (e.g., teaming players 204 together, defeating other player(s) 204, etc.), and/or the like.

The recommendation engine 104 may further generate one or more sequences of combinations of reward recommendations to multiple player groups.

According to some embodiments, the recommendation engine 104 may comprise, utilize and/or apply one or more ML models employing one or more machine learning methodologies, architectures, and/or frameworks. For example, the ML model(s) may include one or more Multi-Armed Bandits (MAB) based models. In another example, the ML model(s) may include one or more perceptron based models, such as, for example, a neural network, such, as for example, a convolutional Neural Network (CNN), a Recurrent Neural Networks (RNN), a Deep Neural Networks (DNN), a classifier, an SVM and/or the like adapted and trained to generate one or more reward recommendations.

The ML model(s) may be trained in one or more supervised, semi-supervised, and/or unsupervised learning session using annotated training datasets and/or unlabeled training datasets comprising a plurality of training samples associating rewards allocated to players such as the players 204 playing one or more computer games with impacts on user experience of the players 204 and long-term factors of the computer game as result of the allocated rewards.

Trained with such training samples, the ML model(s) may adapt, adjust and/or evolve to learn impact patterns and/or relation of rewards allocation on user experience and long-term factors and may further learn to allocate rewards estimated to best balance between the user experience and the long-term factors by rewarding the players 204 and generate reward recommendations accordingly. In particular, the ML model(s) may be trained to generate the reward recommendations in correlation and/or based on a plurality of behavior parameters collected for the plurality of players 204 while engaged with (playing) the computer game.

Moreover, the ML model(s) may be further trained and learned to generate multiple alternative sequences of reward recommendations to identify and select an optimal sequence of reward recommendations estimated to best balance between the user experience of one or more players 204 and one or more of the long-term factors as defined by one or more of the constraints.

As shown at 128, the recommendation engine 104 may interact (communicate) with the game engine 102 and cause the game engine 102 to allocate rewards to one or more of the players 204 according to the reward recommendation(s) selected by the recommendation engine 104.

The recommendation engine 104 may further cause the game engine 102 to allocate rewards to one or more of the players 204 according to a sequence of reward recommendation(s) selected by the recommendation engine 104.

Moreover, in case the players 204 are grouped in a plurality of player groups, the recommendation engine 104 may cause the game engine 102 to allocate rewards to one or more players 204 of one or more of the player groups according to the combination of reward recommendations selected by the recommendation engine 104 for the multiple player groups.

Optionally, responsive of failure of a selected reward recommendation sequence and/or combination to comply with the constraints, the recommendation engine 104 may generate one or more additional sequences and/or combinations of reward recommendations which are estimated to restore and/or improve the balance between the user experience of at least some of the players 204 and the long-term factor(s) defined by the constraints. The time period defined for evaluating failure or success of selected reward recommendation sequences and/or combinations to comply with the constraints, for example, a day, a week, a month, and/or the like may be predefined in advance and/or defined in runtime. For example, assuming it is observed in runtime that the balance is significantly disrupted, for example, one or more of the long-term factors exceed or fall below a certain threshold, the selected reward recommendation sequences and/or combinations may be determined to fail to comply with the constraints.

Furthermore, one or more selected reward recommendation sequences which failed to comply with the constraints may be used to further train the ML model(s) which may adapt and evolve accordingly. Moreover, one or more additional reward recommendation sequences generated in response to failed which failed reward recommendation sequences may be also used to train the ML model(s) which may adapt and evolve accordingly.

As shown at 114, the game engine 102 may receive the selected reward recommendation(s), reward recommendation sequence(s), and/or combinations of reward recommendations and allocate rewards accordingly to one or more of the players 204 which may be optionally grouped in a plurality of player groups (categories).

As shown at 116, the game engine 102 may instruct the GUI 232 executed by the client devices of one or more of the players 204 to reflect the one or more rewards allocated to one or more of the players 204.

As such, the players 204 may be informed of the allocated reward(s) which may improve their user experience in their interaction with the computer game.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms game economy, long-term factors, in-game behavior parameters, and game engine architecture are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of improving user experience in conjunction with a computer game long-term factors by controlling rewards to players, comprising:
using at least one processor for executing a recommendation engine adapted to:
communicate with a game engine of a computer game to receive a plurality of behavior parameters relating to in-game actions of a plurality of players engaged in the computer game using a plurality of client devices;
balance between a user experience of at least one of the plurality of players and at least one long-term factor of the computer game by generating, based on the plurality of behavior parameters, at least one reward recommendation for allocating at least one reward to at least one of the plurality of players for at least one in-game action made by the at least one player; and
cause the game engine to adjust a graphic user interface (GUI) of the client device of at least one of the plurality of players to reflect the at least one allocated reward.

2. The method of claim 1, further comprising applying at least one trained machine learning (ML) model adapted to generate the at least one reward recommendation.

3. The method of claim 1, wherein the plurality of behavior parameters relating to in-game actions of the plurality of players comprise at least one member of a group comprising: engagement time, a churn rate, a growth in number of new players, a retention rate of new players, an in-game action, advancement of players within the computer game, a player interaction, and a value of rewards aggregated by the plurality of players.

4. The method of claim 1, wherein the at least one reward comprises at least one member of a group of: an asset, a token, an experience point (XP), a gaming clue, a level advancement, an in-game advantage, an in-game skill, and a monetary value.

5. The method of claim 1, wherein the at least one long-term factor is expressed by at least one parameter selected from a group of: a value of assets aggregated by the players, a value of assets spent by the players, a ratio between the aggregated assets and the spent assets, a rate of asset purchasing by the players, an inflation rate of assets gained by the players, and a ratio between assets gained by at least some of the plurality of players.

6. The method of claim 1, wherein the balancing is based on a plurality of constraints defining at least that: the increase of assets gained by the at least one player exceeds a predefined threshold, and the at least one long-term factor is within a predefined range.

7. The method of claim 6, wherein the recommendation engine is further adapted to generate a sequence of reward recommendations estimated to comply with the plurality of constraints.

8. The method of claim 7, wherein the recommendation engine is further adapted to test a plurality of alternative sequences of reward recommendations to identify and select an optimal sequence of the plurality of alternative sequences.

9. The method of claim 7, wherein the recommendation engine is further adapted to generate an additional sequence of reward recommendations responsive to a failure of at least one previous sequence to comply with the plurality of constraints.

10. The method of claim 9, further comprising using the additional sequence and/or the at least one failed sequence to further train at least one ML model adapted to generate the sequence of reward recommendations.

11. The method of claim 1, wherein the recommendation engine is further adapted to apply at least one adverse result limitation constraint to the balancing, the at least one adverse result limitation constraint is selected form a group consisting of: a predefined engagement time limit, and a predefined monetary value spending limit.

12. The method of claim 1, wherein the recommendation engine is further adapted to:
group the plurality of players into a plurality of player groups,
collect a plurality of sets of behavior parameters each relating to respective one of the plurality of player groups,
compute a combination of reward recommendations comprising at least one respective reward recommendation for each of the plurality of player groups generated based on a respective one of the plurality of sets, and
cause the game engine to allocate at least one reward to at least one player of each of the plurality of player groups according to the respective at least one reward recommendation.

13. The method of claim 12, wherein the recommendation engine is further adapted to generate the combination of reward recommendations based on mutual impact between players of different groups.

14. The method of claim 12, wherein the recommendation engine is further adapted to generate the reward recommendations according to at least one distribution of rewards among the plurality of player groups.

15. A system for improving user experience in conjunction with a computer game long-term factors by controlling rewards to players, comprising:
at least one processor adapted to execute a code of a recommendation engine, the code comprising:
code instructions to communicate with a game engine of a computer game to receive a plurality of behavior parameters relating to in-game actions of a plurality of players engaged in the computer game using a plurality of client devices;
code instructions to balance between a user experience of at least one of the plurality of players and at least one long-term factor of the computer game by generating, based on the plurality of behavior parameters, at least one reward recommendation for allocating at least one reward to at least one of the plurality of players for at least one in-game action made by the at least one player; and
code instructions to cause the game engine to adjust a graphic user interface (GUI) of the client device of at least one of the plurality of players to reflect the at least one allocated reward.

16. A computer program product of a recommendation engine adapted to improve user experience in conjunction with a computer game long-term factors by controlling rewards to players, comprising a non-transitory medium storing thereon computer program instructions which, when executed by at least one hardware processor, cause the at least one hardware processor to:
communicate with a game engine of a computer game to receive a plurality of behavior parameters relating to in-game actions of a plurality of players using a plurality of client devices to play the computer game;
balance between a user experience of at least one of the plurality of players and at least one long-term factor of the computer game by generating, based on the plurality of behavior parameters, at least one reward recommendation for allocating at least one reward to at least one of the plurality of players for at least one in-game action made by the at least one player; and
cause the game engine to adjust a graphic user interface (GUI) of the client device of the at least one of the plurality of players to reflect the at least one allocated reward.
